(19) United States
(12) Patent Application Publication
(10) Pub. No.: US 2011/0170013 A1
(43) Pub. Date: Jul. 14, 2011

(54) DIGITAL BROADCAST RECEIVER

(76) Inventors: Yoshio Todoroki, Tokyo (JP); Nobuyoshi Okumura, Tokyo (JP); Kazuma Kaneko, Tokyo (JP)

(21) Appl. No.: 13/120,734

(22) PCT Filed: Aug. 13, 2009
(86) PCT No.: PCT/JP2009/003890

§ 371 Date: Mar. 24, 2011

(30) Foreign Application Priority Data
Dec. 24, 2008 (JP) 2008-328718

(51) Int. Cl. H04N 5/455

(52) U.S. Cl. 348/726; 348/E05.113

(57) ABSTRACT

Respective broadcast program videos from a plurality of broadcast reception units 10, 20 are distributed by a video distribution unit 51. Video synthesis units 54, 55 set at least one of the distributed program videos as a master screen, set another program video subjected to reduction processing by video reduction units 52, 53 as a slave screen, and synthesize the program video set as the master screen with the program video set as the slave screen. A video constituted by the synthesized master screen and slave screen is then displayed on each of a plurality of monitors 92, 97.

### TECHNICAL FIELD

The present invention relates to a digital broadcast receiver that has a Picture in Picture (PinP) function and displays program videos selectively received by a plurality of broadcast reception units on a plurality of monitors capable of displaying the individual program images selectively.

### BACKGROUND ART

As a digital broadcast receiver having a Picture in Picture function, Patent Document 1, for example, discloses a digital broadcast receiver that reduces one of two program videos selectively received by two broadcast reception units, respectively, and then synthesizes the two program videos such that a master screen and a slave screen are displayed simultaneously within a single monitor screen.

Further, Patent Document 2 discloses a technique in which two broadcast reception units are provided to correspond respectively to two video displays displayed in different viewing directions on a single monitor, whereby a channel can be selected for each viewing direction.

Furthermore, Patent Document 3 discloses a constitution in which a plurality of slave monitors display usage conditions of broadcast reception units such that a user can select a channel while checking the usage condition display.

### PRIOR ART DOCUMENTS

### Patent Documents

Patent Document 1: Japanese Patent Publication No. 3037041

Patent Document 2: Japanese Patent Application Publication No. 2007-43658

Patent Document 3: Japanese Patent Application Publication No. 2005-143081

### SUMMARY OF THE INVENTION

When a video signal is distributed by the digital broadcast receiver described in Patent Document 1 such that two viewers (viewer 1, viewer 2) respectively view the distributed video signal on two monitors (monitor 1, monitor 2), for example, identical videos are displayed on monitor 1 and monitor 2, and it is therefore impossible to meet viewing preferences of viewer 1 viewing monitor 1 and viewer 2 viewing monitor 2. For example, the digital broadcast receiver cannot meet a situation in which viewer 1 wishes to watch a quiz program, whereas viewer 2 would rather watch a live baseball broadcast than the quiz program (but also wants to know the correct answers to the quiz).

Further, with Patent Document 2, a channel selection operation cannot be performed while two viewers watch two video displays simultaneously, and therefore an important scene of one program may be missed while watching the other program.

Furthermore, although it is possible to select a channel on each slave monitor in Patent Document 3, the slave monitors cannot display a plurality of screens.

The present invention has been designed to solve the problems described above, and an object thereof is to obtain a digital broadcast receiver such that a master screen and a slave screen can be displayed on each of a plurality of monitors with at least two broadcast reception units.

A digital broadcast receiver according to the present invention includes: a plurality of monitors for displaying broadcast programs as program videos; a plurality of broadcast reception units for receiving broadcast waves of the broadcast programs and demodulating the broadcast waves into broadcast program data; a digital decoding unit for separating program video information from the respective broadcast program data demodulated by the plurality of broadcast reception units and decoding the program video information into program videos; a video selection/synthesis unit including a video distribution unit for distributing the program videos decoded by the digital decoding unit, and a video synthesis unit for setting at least one of the program videos distributed by the video distribution unit as a master screen, setting another program video subjected to reduction processing by a video reduction unit as a slave screen, synthesizing the master screen program video with the slave screen program video, and outputting the synthesized program video; and a control unit, provided with an operation input unit for receiving an operation of the monitor from a user, for controlling operations of the broadcast reception units, the digital decoding unit, and the video selection/synthesis unit on the basis of an input from the operation input unit, to thus display videos of the broadcast programs received by the broadcast reception units on the monitors.

In the digital broadcast receiver according to the present invention, respective broadcast program videos from the plurality of broadcast reception units are distributed, whereupon at least one distributed program video is set as a master screen, another program video subjected to reduction processing by the video reduction unit is set as a slave screen, the program video set as the master screen is synthesized with the program video set as the slave screen, and the synthesized program video is output; thus, a master screen and a slave screen can be displayed on each of a plurality of monitors. As a result, viewers of the respective monitors can check a plurality of broadcast videos.

Further, since the broadcast program video of the master screen and the broadcast program video of the slave screen can be switched on each monitor, a user can check the broadcast program content by viewing the slave screen, which makes channel selection easier.

### BRIEF DESCRIPTION OF THE DRAWINGS

FIG. 1 is a block diagram showing the constitution of a digital broadcast receiver according to Embodiment 1.

FIG. 2 is a block diagram showing the internal constitution of a video selection/synthesis unit of the digital broadcast receiver according to Embodiment 1.

FIG. 3-1(a) is a schematic view illustrating a case in which reception instructions for identical programs are detected in relation to a plurality of monitors, and FIG. 3-1(b) is a schematic view illustrating a condition in which a broadcast program received by one broadcast reception unit is distributed following detection such that another broadcast reception unit becomes available.

FIG. 3-2(a) is a schematic view illustrating an operation performed when slave screen display and slave screen program selection are instructed on one monitor side, and FIG. 3-2(b) is a schematic view illustrating an operation performed when slave screen display is instructed on another monitor side.

FIG. 4 is a flowchart showing an operation relating to main screen display.

FIG. 5 is a flowchart showing an operation relating to slave screen display.

FIG. 6(a) is a view showing an example of a broadcast video received by a first broadcast reception unit, and FIG. 6(b) is a view showing an example of a broadcast video received by a second broadcast reception unit.

FIG. 7 is a view showing examples of display screen images on a front seat monitor and a rear seat monitor of the digital broadcast receiver according to Embodiment 1, wherein FIG. 7(a) shows the display screen image of the front seat monitor and FIG. 7(b) shows the display screen image of the rear seat monitor.

FIG. 8 is a view showing a display screen image in a case where a sub-selected program is displayed on a slave screen in the digital broadcast receiver according to Embodiment 1.

FIG. 9 is a block diagram showing the constitution of a digital broadcast receiver according to Embodiment 2.

FIG. 10 is a block diagram showing the internal constitution of a video selection/synthesis unit of the digital broadcast receiver according to Embodiment 2.

FIG. 11 is a flowchart showing an operation for storing program still images.

FIGS. 12(a) and 12(b) are views respectively showing a display screen image of a front seat monitor and a display screen image of a rear seat monitor in the digital broadcast receiver according to Embodiment 2.

FIG. 13 is a view showing a display screen image of a rear seat monitor according to Embodiment 4.

FIGS. 14(a) and 14(b) are views respectively showing a display screen image of a front seat monitor and a display screen image of a rear seat monitor according to Embodiment 5.

FIG. 15 is a view showing a display screen image of a monitor according to Embodiment 6.

FIG. 16 is a view showing a display screen image of a monitor according to Embodiment 7.

FIG. 17 is a view showing a display screen image of a monitor according to Embodiment 8.

FIG. 18 is a view showing a display screen image of a monitor according to Embodiment 9.

### BEST MODE FOR CARRYING OUT THE INVENTION

Embodiments of the present invention will be described below with reference to the attached drawings in order to describe the present invention in further detail.

### Embodiment 1

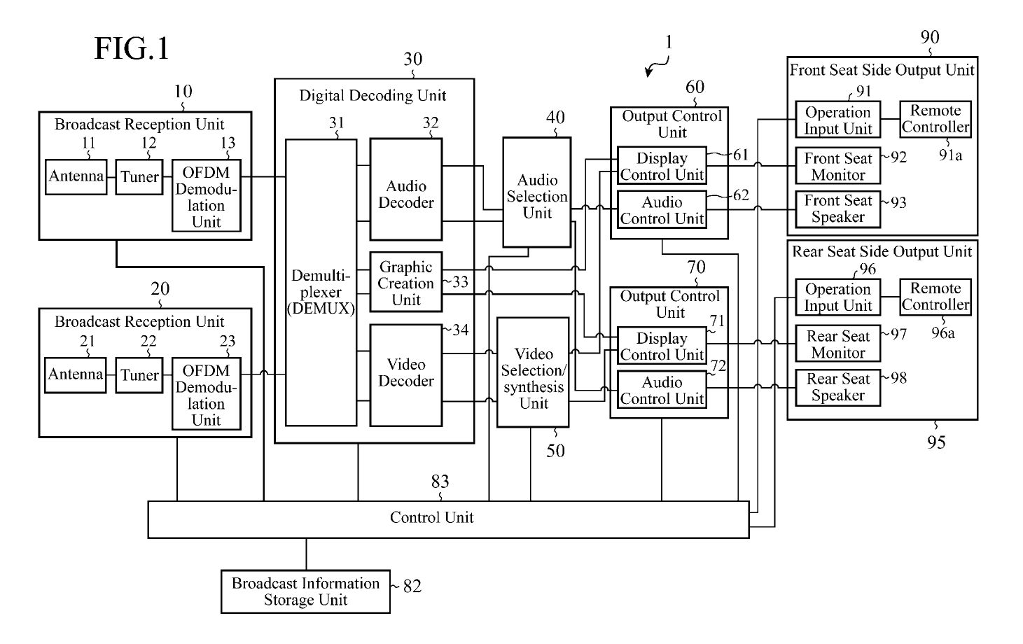

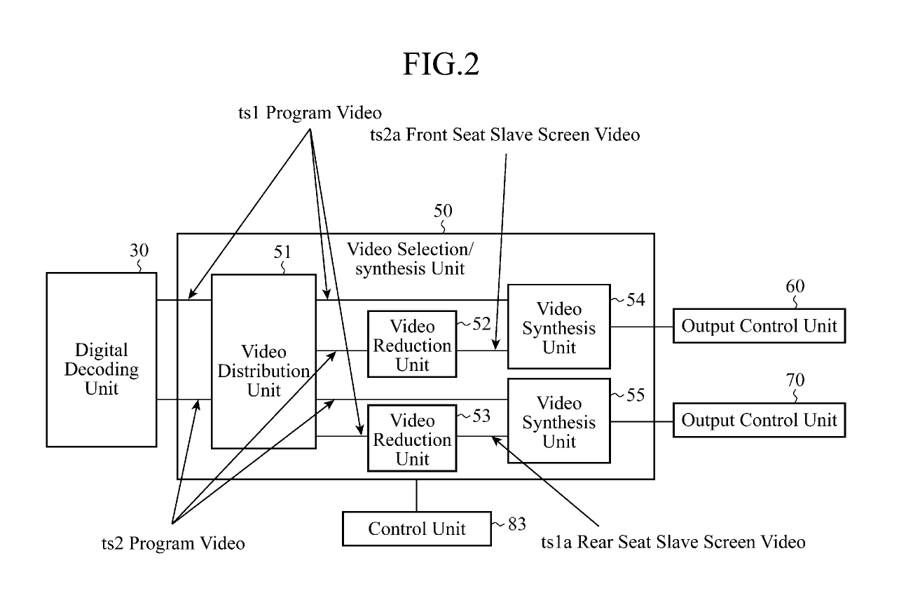

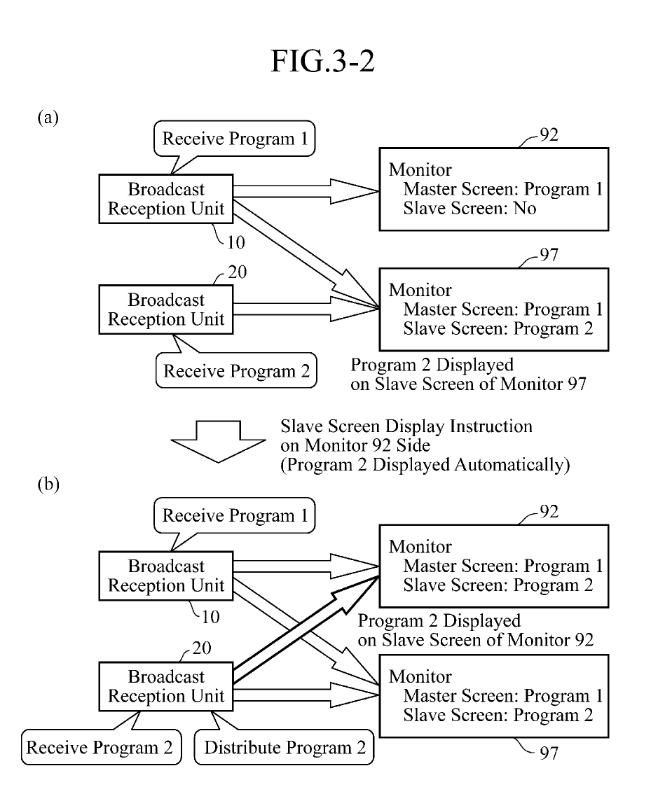

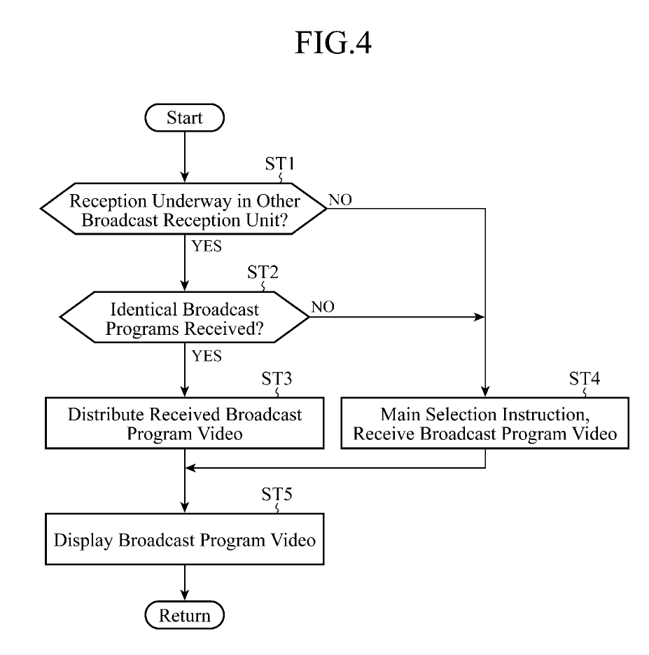

FIG. 1 is a block diagram showing the constitution of a digital broadcast receiver 1. FIG. 2 is a block diagram showing the internal constitution of a video selection/synthesis unit 50 of the digital broadcast receiver 1. FIGS. 3-1 and 3-2 are schematic views illustrating operations performed when identical programs are displayed on two monitors. FIGS. 4 and 5 are flowcharts showing operations of the digital broadcast receiver 1.

Note that in FIGS. 3-1 and 3-2, constitutions have been partially omitted for ease of description.

As shown in FIG. 1, the digital broadcast receiver 1 according to Embodiment 1 is constituted by a first broadcast reception unit 10 and a second broadcast reception unit 20 serving as a plurality of reception units, a digital decoding unit 30, an audio selection unit 40, a video selection/synthesis unit 50, a first output control unit 60, a second output control unit 70, and a first output unit 90 and a second output unit 95 serving as a plurality of output units. Thus, the digital broadcast receiver 1 has a substantially identical constitution to a normal digital broadcast receiver.

The first broadcast reception unit 10 and the second broadcast reception unit 20 are respectively constituted by antennae 11, 21, tuners 12, 22, and OFDM (Orthogonal Frequency Division Multiplexing) demodulation units 13, 23.

In the broadcast reception units 10, 20, the antennae 11, 21 receive terrestrial digital television broadcast waves (broadcast waves hereafter) of desired channels selected by the tuners 12, 22 from among broadcast waves broadcast on channels 13 to 62 in a UHF (Ultra High Frequency) band, whereupon the broadcast waves are subjected to OFDM demodulation by the OFDM demodulation units 13, 23 and then transmitted to the digital decoding unit 30.

The digital decoding unit 30 is constituted by a demultiplexer 31, an audio decoder 32, a graphic creation unit 33, and a video decoder 34.

The demultiplexer 31 separates a transport stream (to be abbreviated to TS hereafter) transmitted after being packetized as broadcast program data into program audio information (an audio stream), program video information (a video stream), and broadcast information (a carousel, SI (Service Information), an EPG (Electronic Program Guide), and so on).

The audio decoder 32 decodes the program audio information and outputs a program audio. The video decoder 34 decodes the program video information and outputs a broadcast program video. The graphic creation unit 33 creates graphics such as a data broadcast, closed captions, and program listings from the broadcast information and outputs the created graphics.

The audio selection unit 40 selects and outputs an audio from a plurality of broadcast program audios output by the audio decoder 32. The video selection/synthesis unit 50 selectively synthesizes a program video from a plurality of program videos output by the video decoder 34 and outputs the synthesized video to each of the output portions 90, 95.

As shown in FIG. 2, the video selection/synthesis unit 50 is constituted by a video distribution unit 51, video reduction units 52, 53, and video synthesis units 54, 55.

The video distribution unit 51 distributes a broadcast program video from the digital decoding unit 30, and the two video reduction units 52, 53 create slave screen videos (reduced videos) in response to an instruction from a control unit 83.

The two video synthesis units 54, 55 respectively synthesize at least one broadcast program video distributed by the video distribution unit 51 with a program video reduced by the video reduction units 52, 53 to generate a master screen and a slave screen, respectively.

The output control units 60, 70 are constituted respectively by display control units 61, 71 and audio control units 62, 72, wherein the audio control units 62, 72 control a program audio to be transmitted to front seat and rear seat speakers 93, 98.

The display control units 61, 71 synthesize a graphic created by the graphic creation unit 33 with the broadcast program video from the video selection/synthesis unit 50 and output the result to monitors 92, 97.

A broadcast information storage unit 82 stores the broadcast information separated from the TS by the digital decoding unit 30. The control unit 83 controls the entire digital broadcast receiver 1 on the basis of signals from operation input units 91, 96 for receiving operations performed on each of a plurality of operating units.

In Embodiment 1, the output units 90, 95 are disposed respectively on a front seat side and a rear seat side, and will therefore be referred to as a front seat side output unit 90 and a rear seat side output unit 95. The front seat side output unit 90 and the rear seat side output unit 95 are respectively constituted by the operation input units 91, 96, remote controllers 91a, 96a for transmitting signals to the operation input units 91, 96 in order to execute remote operations, the monitors 92, 97, and the speakers 93, 98.

The operation input units 91, 96 transmit operation content input by a user using operating buttons, not shown in the drawings, provided on the remote controllers 91a, 96a or the operation input units 91, 96 to the control unit 83.

The monitors 92, 97 output broadcast program video from the output control units 60, 70 as video output, and the speakers 93, 98 output broadcast program audio from the output control units 60, 70 as audio output.

Note that hardware used in each constitutional component of the digital broadcast receiver 1 is similar to that of a household digital television receiver. For example, parts corresponding to the broadcast reception units 10, 20 are constituted by radio wave reception circuits, tuners, and a digital demodulation LSI (Large Scale Integration) circuits, the digital decoding unit 30 is an LSI for multiple input/multiple output MPEG (Moving Picture Experts Group) processing, parts corresponding to the output control units 60, 70 are constituted by audio output circuits and video output circuits, parts corresponding to the operation input units 91, 96 are constituted by remote control reception circuits or the like, a part corresponding to the broadcast information storage unit 82 is constituted by a volatile memory or a non-volatile memory, and a part corresponding to the control unit 83 is constituted by a microcomputer and a volatile memory or a non-volatile memory.

Next, an overall operation of the digital broadcast receiver 1 will be described. A terrestrial digital broadcast wave is received by the respective parts of the broadcast reception units 10, 20. The tuners 12, 22 select desired channels of the broadcast wave, and the antennae 11, 21 receive terrestrial digital television broadcast waves broadcast on channels 13 to 62 in the UHF band. The received broadcast wave is subjected to OFDM demodulation by the OFDM demodulation units 13, 23 and output in the form of a TS serving as broadcast program data. A TS is a data sequence (a stream) obtained by multiplexing video/audio, program information serving as broadcast information, a data broadcast, closed captions, and so on in compliance with MPEG-2 standards and the standard specifications of ARIB (Association of Radio Industries and Businesses).

Hereafter, to differentiate between TSs, the TS output by the broadcast reception unit 10 will be referred to as TS1 and the TS output by the broadcast reception unit 20 will be referred to as TS2. Further, suffixes ts1, ts2 will be attached. For example, information separated from TS1 will be referred to as an audio stream ts1, a video stream ts1, and broadcast information ts1, while information separated from TS2 will be referred to as an audio stream ts2, a video stream ts2, and broadcast information ts2. Note, however, that when there is no need to differentiate, these suffixes will not be attached.

In the digital decoding unit 30, the broadcast program data demodulated respectively by the plurality of broadcast reception units 10, 20 are decoded into program videos or the like in a format that can be displayed by the monitors 92, 97.

First, the multiplexed information in TS1 and TS2 is analyzed and separated into program audio information, program video information, and broadcast information by the demultiplexer 31.

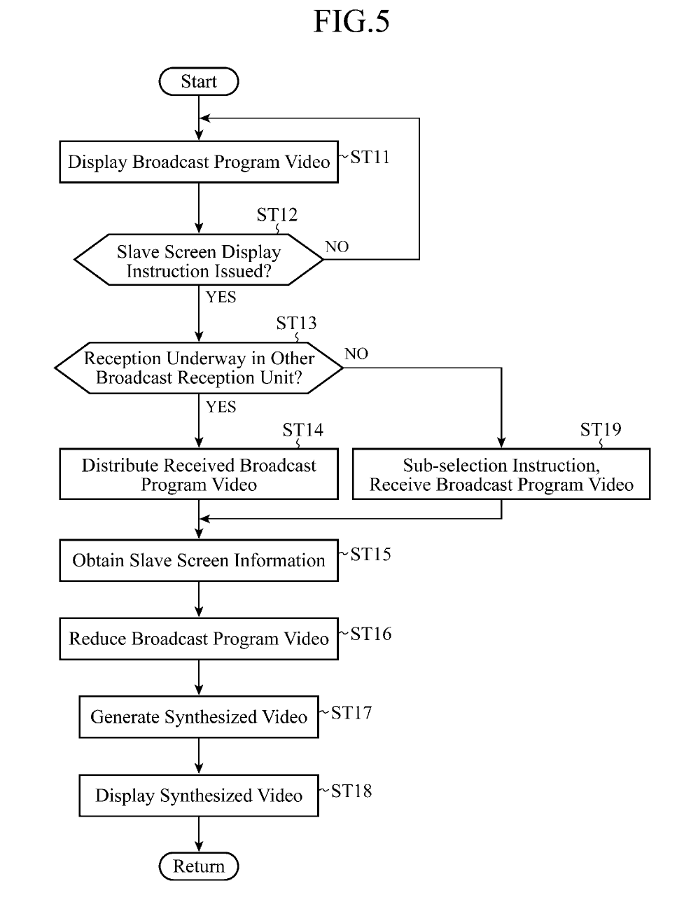

The broadcast information separated by the demultiplexer 31 is input into the control unit 83, subjected to data processing, and then stored in the broadcast information storage unit 82. The graphic creation unit 33 reads the stored broadcast information and creates graphics such as a program listing, a data broadcast screen, and closed captions. In the audio decoder 32, the audio stream ts1 and the audio stream ts2 separated by the demultiplexer 31 are decoded and output as a program audio ts1 and a program audio ts2. In the video decoder 34, the video stream ts1 and the video stream ts2 separated by the demultiplexer 31 are decoded and output as a program video ts1 (FIG. 6(a)) and a program video ts2 (FIG. 6(b)).

The digital decoding unit 30 is capable of inputting a plurality of TSs and outputting program videos, program audios, and graphics to a plurality of output destinations to thereby perform multiple input/multiple output. In Embodiment 1, for example, two TSs are input and output to two output destinations.

In the output control units 60, 70, the display control units 61, 71 synthesize the videos output by the video selection/synthesis unit 50 with graphics relating to a data broadcast, closed captions, subtitles, an EPG, and so on and menu screen graphics output by the graphic creation unit 33, and output the results to the respective monitors 92, 97.

Note that a case in which the menu screen graphics are created by the control unit 83 is envisaged, but the menu screen graphics may be created by the graphic creation unit 33.

The program audios output from the digital decoding unit 30 are input into the audio selection unit 40, whereupon the program audio ts1 is allocated to the audio control unit 62 and the program audio ts2 is allocated to the audio control unit 72. The audio control units 62, 72 perform control such as volume adjustment, whereupon the program audio ts1 is output from the front seat speaker 93 to a front seat user and the program audio ts2 is output from the rear seat speaker 98 to a rear seat user.

Hereafter, master screen display by the monitors 92, 97 of the output units 90, 95 is defined as main display, main display by the monitor of the other seat output unit is defined as other seat main display, selection of a main display broadcast program by a broadcast reception unit corresponding to a monitor is defined as main selection, and selection of a broadcast program to be displayed on a slave screen by an available broadcast reception unit is defined as sub-selection.

Further, broadcast program videos received by the first and second broadcast reception units and the videos displayed as main displays on the front seat monitor 92 and rear seat monitor 97 are defined as program videos ts1, ts2, while videos obtained by reducing the broadcast program videos ts1, ts2 are defined as slave screen videos ts1a, ts2a. The video displayed on the front seat monitor 92 is defined as a front seat monitor video 92a, and the video displayed on the rear seat monitor 97 is defined as a rear seat monitor video 97a.

First, an operation performed to display identical broadcast programs on the plurality of monitors 92, 97 will be described.

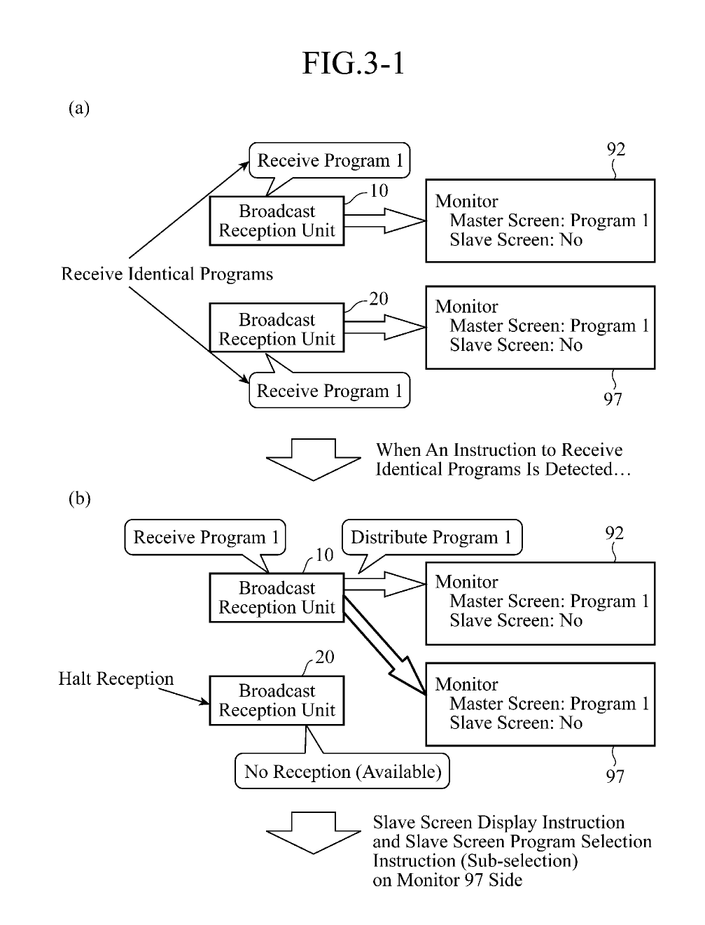

The users of the respective monitors 92, 97 input instructions relating to main display and main selection into the operation input units 91, 96 provided respectively for the plurality of monitors 92, 97 via the remote controllers 91a, 96a. As shown in FIG. 3-1(a), in a case where selective reception instructions relating to identical broadcast programs are is sued with respect to the plurality of monitors 92, 97 such that the broadcast reception units 10, 20 receive an identical broadcast program 1, the control unit 83 detects selective reception instructions relating to the same program. As shown in FIG. 3-1(b), having detected the selective reception instructions relating to the same program, the control unit 83 performs control to interrupt broadcast program reception by the broadcast reception unit 20 and distribute the broadcast program video received by the broadcast reception unit 10 such that the monitors 92, 97 requesting the same program display the broadcast program video distributed thereto. At this time, the broadcast reception unit 20 does not perform reception and therefore becomes available.

When a slave screen display instruction and a slave screen program selection instruction (sub-selection) are issued on the monitor 97 side in this state, the control unit 83 outputs a reception selection instruction signal to the broadcast reception unit 20, as shown in FIG. 3-2(a), whereby the broadcast program 1 is displayed as the master screen of the monitor 97 and a program video of a broadcast program 2 received by the broadcast reception unit 20 is displayed as the slave screen of the monitor 97.

Further, as shown in FIG. 3-2(b), when a slave screen display instruction is issued by the operation input unit 91 on the monitor 92 side in this case, the control unit 83 performs control such that the program video of the broadcast program 2 received by the broadcast reception unit 20 is automatically displayed as the slave screen of the monitor 92.

In such a way, in a case where identical broadcast programs are received by a plurality of monitors, the broadcast program received by one broadcast reception unit is unified rather than having the plurality of broadcast reception units receive the same broadcast program. As a result, an available broadcast reception unit is generated, and the available broadcast reception unit is used to receive a program not being received by the other broadcast reception unit.

Next, a specific control will be described with reference to FIG. 4.

As shown in FIG. 4, when a main display instruction is issued by the rear seat side output unit 95, for example, first a determination is made as to whether or not program video display is underway in the front seat side output unit 90, or in other words whether or not a broadcast program is being received by the first broadcast reception unit 10 (step ST1).

When reception is underway by the first broadcast reception unit 10 in the step ST1 (YES), a determination is made as to whether or not the received broadcast program and the instructed broadcast program are identical (step ST2).

When it is determined in the step ST2 that an identical broadcast program is being received (YES), the received broadcast program video ts1 or ts2 distributed (step ST3) by the video distribution unit 51 is output from the monitor 97 of the rear seat side output unit 95 and displayed (step ST5).

When a broadcast program video is not being received by the first broadcast reception unit 10 in the step ST1 (NO) and it is determined in the step ST2 that the instructed broadcast program is not identical to the broadcast program ts1 received by the first broadcast reception unit 10 (NO), the second broadcast reception unit 20 is instructed to perform main selection, whereby the program video ts2 is received by the second broadcast reception unit 20 (step ST4).

The broadcast program video ts1 or ts2 received in the step ST4 is then output from the monitor 97 of the rear seat side output unit 95 and displayed (step ST5).

As mentioned above, in the digital broadcast receiver 1 according to Embodiment 1, respective decoded broadcast program videos received from the plurality of broadcast reception units 10, 20 are distributed to the plurality of monitors 92, 97 for display thereon. Therefore, in a case where identical broadcast programs are displayed on the plurality of monitors, only one broadcast reception unit is required for a single program, and therefore another broadcast program can be received by the available broadcast reception unit. As a result, different broadcast programs can be displayed on the master screen and the slave screen of each of the plurality of monitors.

Next, a slave screen display operation will be described.

FIG. 5 is a flowchart showing a slave screen display operation performed by the digital broadcast receiver 1. FIG. 6(a) shows an example of the broadcast video ts1 received by the first broadcast reception unit 10, and FIG. 6(b) shows an example of the broadcast video ts2 received by the second broadcast reception unit 20.

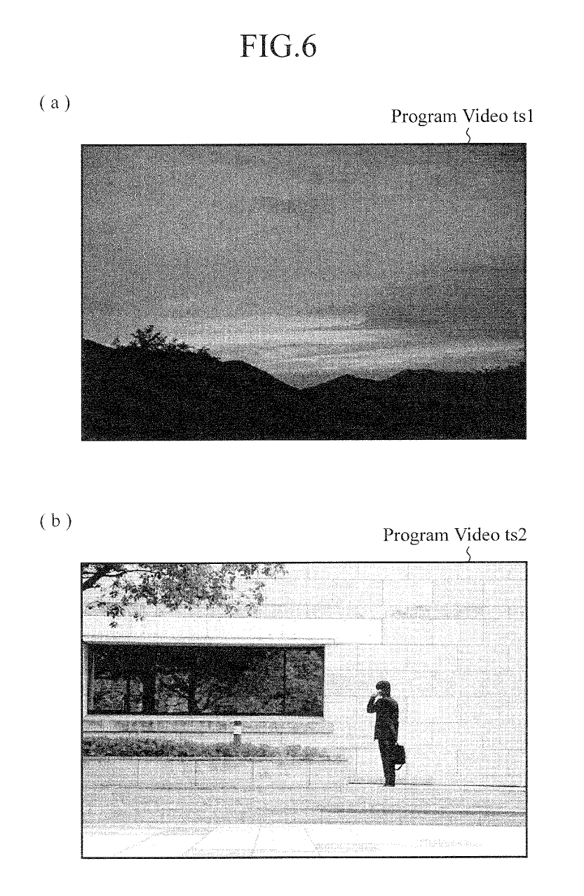

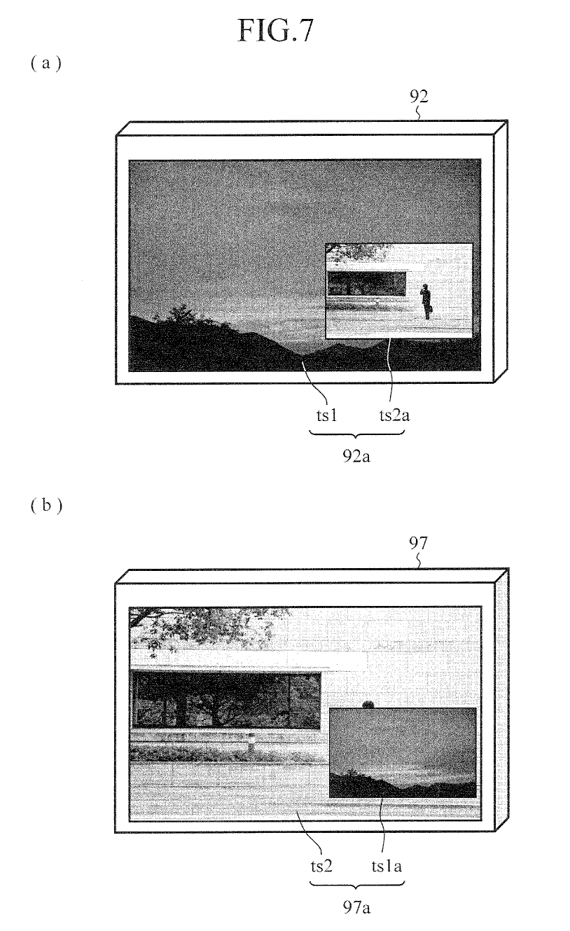

Further, FIGS. 7(a) and 8(a) show examples of videos displayed on the slave screen of the front seat monitor 92, while FIGS. 7(b) and 8(b) show examples of videos displayed on the slave screen of the rear seat monitor 97.

For the sake of simplicity, a specific example of display in the rear seat side output unit 95 will be described below. Further, users viewing the respective monitors 92, 97 from the front seat side and the rear seat side will be referred to respectively as a front seat user and a rear seat user, or simply as users when there is no need to differentiate between the front seat and the rear seat.

As shown in FIG. 5, first, the rear seat user uses the remote controller 96a to switch a power supply of the output unit 95 ON via the operation input unit 96, whereby the rear seat monitor 97 displays a broadcast program video ts2 from the broadcast reception unit 20 such as that shown in FIG. 6(a) as a main display video (step ST11).

The control unit 83 waits for an instruction relating to slave screen display to be issued (step ST12), and maintains the state of the step ST11 until an instruction is issued (NO).

When an instruction relating to slave screen display is issued by the rear seat side output unit 95, for example, in a step ST12 (YES), a determination is made as to whether or not a main display video is currently displayed on the front seat monitor 92 of the front seat side output unit 90, or in other words whether or not a broadcast program is being received by the first broadcast reception unit 10 (step ST13).

When the broadcast program video ts1 is being received by the broadcast reception unit 10 in the step ST13 (YES), the broadcast program video ts1 distributed (step ST14) by the video distribution unit 51 is transmitted to the video reduction unit 53.

The video selection/synthesis unit 50 obtains slave screen information indicating a size of the slave screen and slave screen position setting information from the control unit 83 (step ST15). The video reduction unit 53 then reduces the broadcast program video ts1 in accordance with the slave screen information and outputs a slave screen video ts1a (step ST16).

The video synthesis unit 55 generates a synthesized video by synthesizing the broadcast program video ts2 displayed by the rear seat side output unit 95 as the main display with the slave screen video ts1a reduced in the step ST16 on the basis of the slave screen information (step ST17).

The synthesized video is transmitted to the display control unit 71 of the output control unit 70 and displayed by the rear seat monitor 97, as shown in FIG. 7(b) (step ST18). At this time, the display on the front seat monitor 92 is as shown in FIG. 7(a).

When the power supply of the front seat monitor 92 is OFF in the step ST13, or in other words when a broadcast program is not being received by the first broadcast reception unit 10, the broadcast program video ts1 is obtained by having the first broadcast reception unit 10 receive a broadcast program in response to a sub-selection instruction from the rear seat side output unit 95 (step ST19), whereupon the operation is performed from the step ST15 onward such that the synthesized video 97a is output, as shown in FIG. 8(a), for example. At this time, the front seat monitor 92 does not display a broadcast program video, as shown in FIG. 8(b), for example.

Note that a slave screen display operation relating to the front seat side output unit 90 is performed similarly to that of the rear seat side output unit 95, and therefore descriptions of this operation are omitted.

As mentioned above, when a slave screen is being displayed, switching can be made on the basis of a user operation such that the broadcast program displayed on the monitor as the master screen is set as the slave screen and the broadcast program displayed as the slave screen is displayed as the master screen.

For example, when the broadcast program video ts2 is displayed as the master screen and the broadcast program video ts1a is displayed as the slave screen on the rear seat monitor 97 of the rear seat side output unit 95, as shown in FIG. 7(b), and an operation is performed on the remote controller 96a by the rear seat side user to switch the broadcast program video ts2 displayed as the master screen and the broadcast program video ts1a displayed as the slave screen on the rear seat monitor 97, the broadcast program video ts1 is set as the master screen and a reduced program video ts2a obtained by reducing the broadcast program video ts2 is set as the slave screen. The master screen video is then synthesized with the slave screen video, whereupon the resulting synthesized video is displayed on the monitor 97.

The broadcast program displayed on the master screen and the broadcast program displayed on the slave screen can be switched in relation to the front seat side output unit 90 through a similar operation.

As described above, the video selection/synthesis unit 50 of the digital broadcast receiver 1 of Embodiment 1 includes a video distribution unit for distributing a program video and a video synthesis unit for setting at least one program video distributed by the video distribution unit as a master screen, setting another program video subjected to reduction processing by a video reduction unit as a slave screen, synthesizing the master screen program video with the slave screen program video, and outputting the synthesized program video, and therefore identical broadcast program videos can be displayed simultaneously as a master screen or a slave screen on a plurality of monitors.

Further, on the basis of an operation performed by the user, switching can be made such that the broadcast program displayed on the monitor as the master screen is displayed as the slave screen and the broadcast program displayed as the slave screen is displayed as the master screen, and therefore the user can perform channel selection easily while checking the broadcast program displayed on the slave screen.

Note that in Embodiment 1, the broadcast program videos of two programs from the two broadcast reception units are displayed on the master screen and slave screen of two monitors, but the number of monitors is not limited to two, and as long as a broadcast program video of a single program is distributed in accordance with the number of monitors, a master screen and a slave screen can be displayed on two or more monitors at the same time.

### Embodiment 2

The digital broadcast receiver 1 according to Embodiment 1 is constituted such that a master screen and a slave screen are displayed on each of a plurality of monitors using two broadcast reception units. The digital broadcast receiver 1 according to Embodiment 2, on the other hand, is provided with three broadcast reception units such that while a master screen and a slave screen are displayed on each monitor by two of the broadcast reception units, program still images of another broadcast program are stored in the other broadcast reception unit and the stored program still images are displayed sequentially on each monitor as a new slave screen.

Note that similar constitutions and operations to those of Embodiment 1 are allocated with identical reference symbols, and descriptions thereof are omitted.

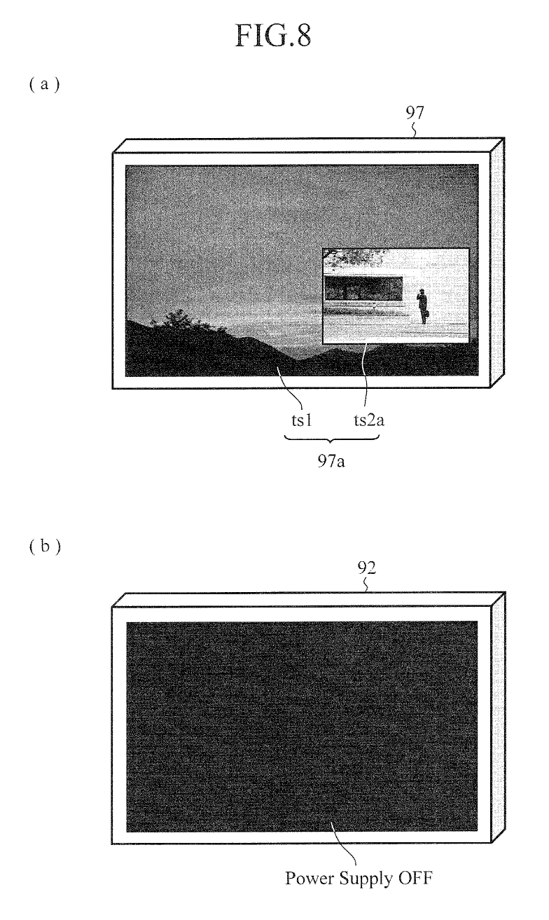

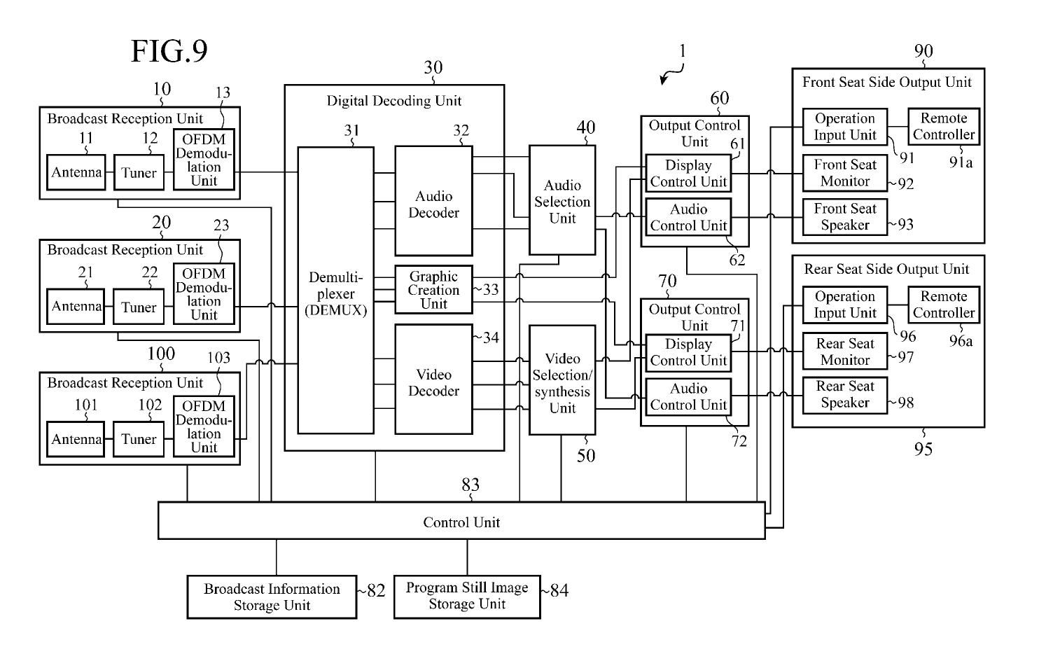

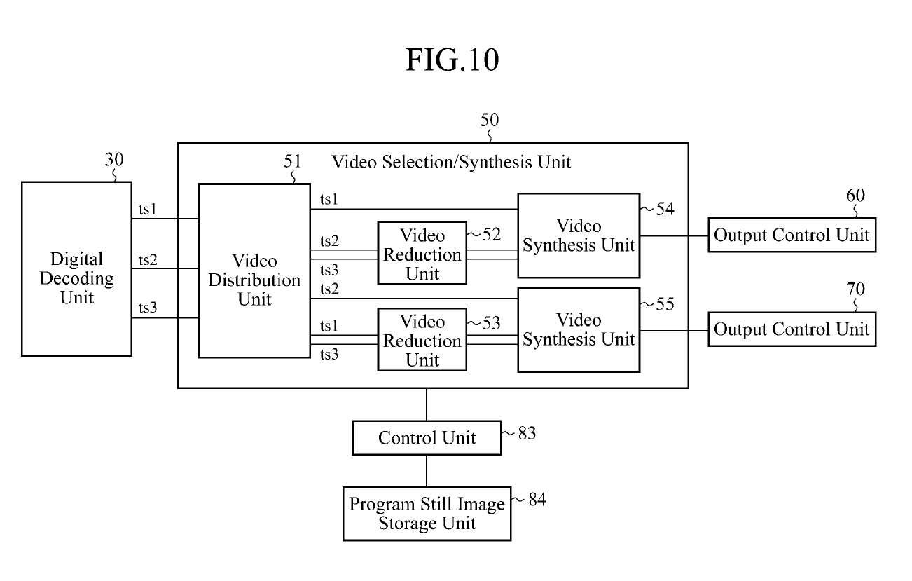

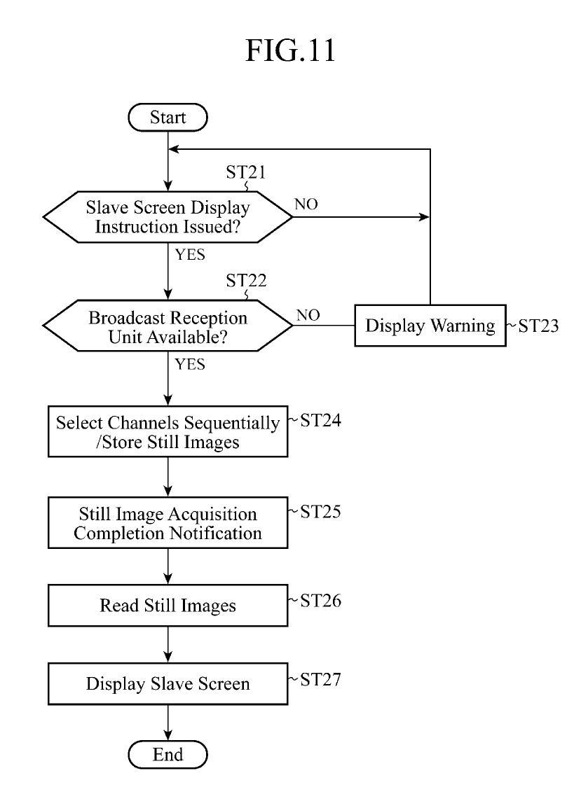

FIG. 9 is a block diagram showing the constitution of the digital broadcast receiver 1. FIG. 10 is a block diagram showing the internal constitution of the video selection/synthesis unit 50 of the digital broadcast receiver 1. FIG. 11 is a flowchart showing an operation for storing program still images. FIG. 12(a) is a display screen image of the front seat monitor 92, and FIG. 12(b) is a display screen image of the rear seat monitor 97.

As shown in FIG. 9, the digital broadcast receiver 1 includes, in addition to the broadcast reception units 10, 20 of the digital broadcast receiver 1 according to Embodiment 1, a third broadcast reception unit 100. The third broadcast reception unit 100 is constituted by an antenna 101, a tuner 102, and an OFDM demodulation unit 103, and has the same constitution as that of the broadcast reception units 10, 20. Broadcast program data from the broadcast reception unit 100 are transmitted to the digital decoding unit 30 together with the broadcast program data from the broadcast reception units 10, 20.

A program still image storage unit 84 is further provided for storing still images of broadcast program videos selected sequentially by one of the tuners 12, 22, 102.

Except provision of the program still image storage unit 84 and the broadcast reception unit 100, the digital broadcast receiver is constituted substantially identically to the digital broadcast receiver of Embodiment 1.

Next, an operation thereof will be described.

As shown in FIG. 11, first, a standby state is maintained until a slave screen display instruction is issued by the user on the remote controller 91a, 96a via the operation input unit 91, 96 (step ST21). When a slave screen display instruction is issued (YES), the presence of an unused broadcast reception unit is determined (step ST22), and when all of the broadcast reception units are in use (NO), a warning indicating that the operation cannot be performed is displayed on the monitor (step ST23), whereupon the routine returns to the step ST21.

If, in the step ST22, a main viewing program on the front seat monitor 92 is being received by the broadcast reception unit 10 and a main viewing program on the rear seat monitor 97 is being received by the broadcast reception unit 20, this means that the broadcast reception unit 100 is available. When, in this state, an unused broadcast reception unit is determined to exist in the step ST22 (YES), the unused broadcast reception unit 100 is controlled such that the tuner 102 selects channels sequentially and the selected broadcast programs are received by the antenna 101. Still images are generated from received broadcast program videos ts3 by the video decoder 34 and stored in the program still image storage unit 84 as still image data ts3m (m=a, b, c, . . . ) every time a channel is selected (step ST24).

When the video selection/synthesis unit 50 receives a signal indicating that acquisition of a program still image is complete (step ST25), the video selection/synthesis unit 50 reads the still image data ts3a from the program still image storage unit 84 via the control unit 83 (step ST26), creates a reduced program still image ts3a′ on the basis of the slave screen setting information, and displays the reduced program still image ts3a′ as a slave screen (step ST27).

In the step ST27, as well as creating the program still image ts3a′, the video selection/synthesis unit 50 reads still image data ts3b, performs similar reduction processing to generate a program still image ts3b′, and displays the program still image ts3b′ as a slave screen on the monitor. Thus, a master screen and three slave screens are displayed on the monitors 92, 97, as shown in the examples of FIGS. 12(a) and 12(b). Of the three slave screens shown in FIG. 12(a), one slave screen displays the slave screen video ts2a of the program video ts2 received from the second broadcast reception unit 20, and the other two slave screens display the slave screen still images ts3a′, ts3b′ subjected to slave screen processing by reducing the stored program still images ts3a, ts3b of the program videos ts3.

Similarly, of the three slave screens shown in FIG. 12B, one slave screen displays the slave screen video ts1a of the broadcast program video ts1 received from the first broadcast reception unit 10, and the other two slave screens display the slave screen still images ts3a′, ts3b′ obtained by subjecting the stored program still images ts3a, ts3b of the program videos ts3 to slave screen processing.

As mentioned above, by providing the digital broadcast receiver 1 according to Embodiment 2 with the third broadcast reception unit 100 and the program still image storage unit 84 and storing the broadcast program video from the third broadcast reception unit 100 in the form of program still images, receivable broadcast programs can be displayed as slave screens on each of the plurality of monitors in the form of still images.

Further, by displaying the receivable broadcast programs as slave screens on each monitor in the form of still images, each viewer can select a channel after checking the content of the receivable broadcast programs, and therefore the users can perform channel selection easily.

Note that in Embodiment 2, ts3a and ts3b are used as the program still images ts3m, but the program still images displayed on the monitors are not limited to ts3a and ts3b, and any constitution in which the stored program still images are displayed sequentially may be employed.

Furthermore, when the monitors 92, 97 are in-vehicle monitors, a display area is small, and therefore the user may perform an operation to switch the program still images ON or OFF.

Further, by providing even more broadcast reception units, a plurality of available broadcast reception units can be generated, and thus a plurality of broadcast reception units can be used to obtain still images in parallel.

Moreover, in Embodiment 2, two output units are described, but three output units may be provided, and when three broadcast reception units are provided in addition to the three output units, two or more slave screens can be displayed by displaying a slave screen of the main viewing program of another seat or a slave screen generated through sub-selection.

### Embodiment 3

In Embodiment 2, a constitution in which the program still images ts3m of the receivable broadcast program videos ts3 are stored by using the broadcast reception unit 100 not receiving a broadcast program, and the stored program still images ts3m are read and displayed on slave screens sequentially is described. However, in Embodiment 3, an example in which program still images are stored periodically by an unused broadcast reception unit will be described.

Note that the constitution of the digital broadcast receiver 1 is similar to that of FIGS. 9 and 10. Therefore, identical reference numerals are applied thereto, and these detailed descriptions are omitted.

The control unit 83 constantly determines whether or not any of the broadcast reception units 10, 20, 100 is available. When a broadcast reception unit becomes available, all of the programs that can be received on channels 13 to 62 are selected periodically in order to obtain program still images.

As described above, according to the digital broadcast receiver 1 of Embodiment 3, the program still images are updated periodically when a broadcast reception unit becomes available, and therefore the respective users can grasp the latest content of the broadcast programs. As a result, the users can perform channel selection even more easily.

### Embodiment 4

In Embodiment 2, an example in which program videos are obtained by an available broadcast reception unit and stored still images are displayed on slave screens is described. However, in Embodiment 4, an example in which the available broadcast reception unit obtains a broadcast program still image first and then receives the program video of the program displayed by the still image will be described.

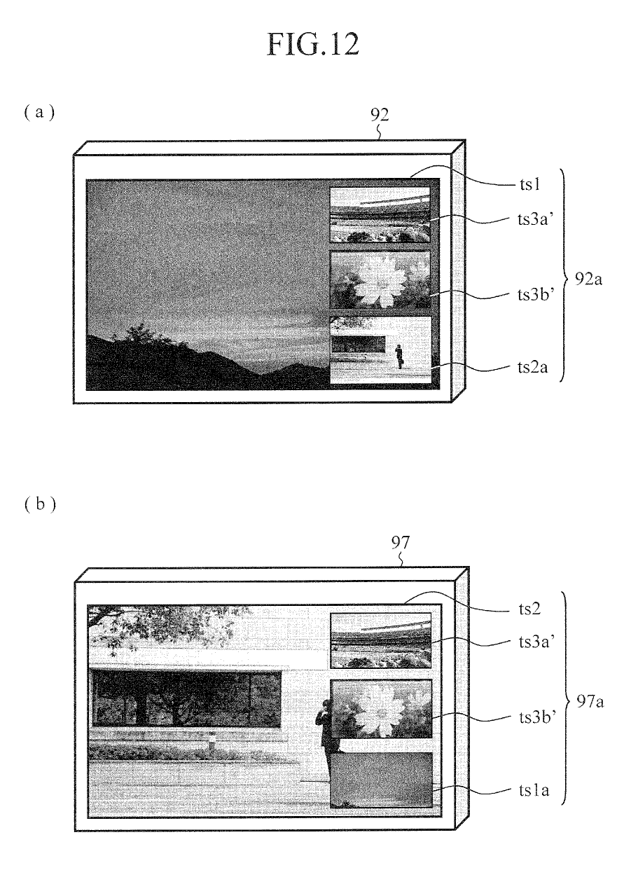

FIG. 13 is an image showing an example of a screen display on the rear seat monitor 97.

Note that the constitution of the digital broadcast receiver 1 is similar to that of FIGS. 9 and 10. Therefore, identical reference numerals are applied thereto, and these detailed descriptions are omitted.

On the basis of a notification indicating that acquisition of a program still image is completed in the step ST25 of the flowchart shown in FIG. 11, the control unit 83 of the digital broadcast receiver 1 instructs the graphic creation unit 33 to create a selection frame graphic g1.

The created selection frame graphic g1 is displayed on the screens of the monitors 92, 97 by the display control units 61, 71, whereupon the slave screen ts3a′ shown in FIG. 12B is selected through a user operation.

The broadcast reception unit 100 selects the broadcast program of the selected slave screen ts3a′ using the tuner 102 and switches the program still image displayed on the slave screen of the monitors 92, 97 to the broadcast program video ts3. Thus, two broadcast program videos received by the first broadcast reception unit 10 and the third broadcast reception unit 100 are displayed on slave screens, as shown in FIG. 13.

As described above, according to the digital broadcast receiver 1 of Embodiment 4, the available broadcast reception unit 100 obtains a still image first and then selects the broadcast program of the selected still image ts3a′ such that the broadcast program video ts3 is displayed on a slave screen as a moving image. As a result, the user can select a channel more easily.

Note that by increasing the number of broadcast reception units in Embodiment 2, an unused broadcast reception unit can be used to select a displayed program, whereby the still image can be modified to a broadcast program video constituted by a moving image.

### Embodiment 5

In Embodiment 4, an example in which the unused broadcast reception unit 100 obtains a still image and then selects the broadcast program of the selected still image is described. However, in Embodiment 5, an example in which slave screens of two broadcast program videos (moving images) are displayed respectively on the front and rear seat monitors 92, 97 will be described.

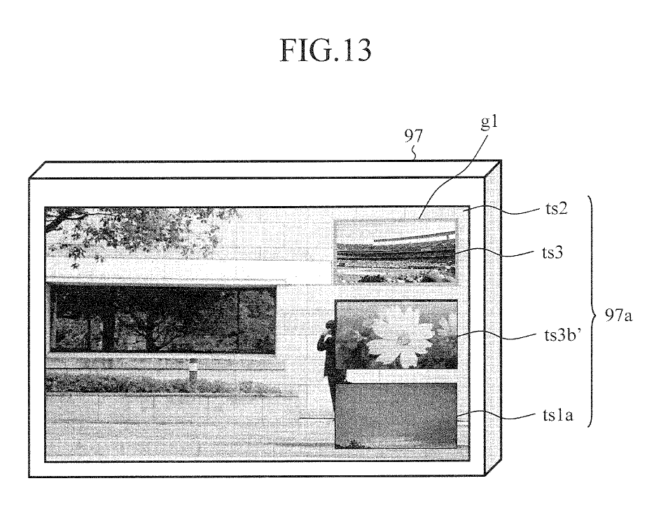

FIG. 14(a) is an image showing an example of a screen display on the front seat monitor 92, and FIG. 14(b) is an image showing an example of a screen display on the rear seat monitor 97.

Note that the constitution of the digital broadcast receiver 1 is similar to that of FIGS. 9 and 10. Therefore, identical reference numerals are applied thereto, and these detailed descriptions are omitted.

When sub-selection is performed by the front seat side output unit 90 or the rear seat side output unit 95, the sub-selected broadcast program video is displayed as an identical slave screen display on the monitors 92, 97 of both the front seat side and the rear seat side output units 90, 95. Thus, two broadcast program videos are displayed together with the slave screen of the broadcast program video serving as the main viewing display of the other seat side.

As described above, according to the digital broadcast receiver 1 of Embodiment 5, in a case where an identical broadcast program video to a sub-selected slave screen video is displayed on a slave screen by one of the output units, the sub-selected program video is distributed so as to be displayed on a slave screen of the other output unit. Therefore, two slave screen videos can be displayed by a single output unit, and as a result, the user can see the content of the broadcast programs and select a channel more easily.

### Embodiment 6

In Embodiment 2, a case in which program still images are obtained by the available broadcast reception unit is described. When acquisition of a still image of a broadcast program is underway in Embodiment 6, on the other hand, a message indicating that acquisition is underway is displayed on the screens of the monitors 92, 97.

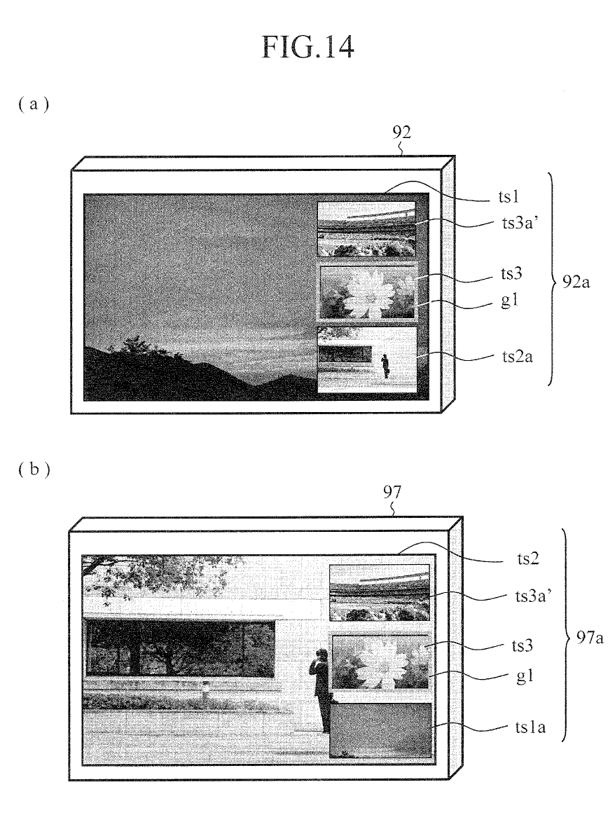

FIG. 15 is an image showing an example of a display screen on the monitor 97.

Note that the constitution of the digital broadcast receiver 1 is similar to that of FIGS. 9 and 10. Therefore, identical reference numerals are applied thereto, and these detailed descriptions are omitted.

As shown in FIG. 15, the still images ts3a′, ts3b′ of the broadcast programs selected in sequence by the broadcast reception unit 100 are displayed, and when acquisition of a still image to be displayed on a third slave screen is underway, the graphic creation unit 33 creates a graphic g2 indicating that program still image acquisition is underway. The created graphic g2 is then synthesized with the video in the display control units 61, 71 and displayed on the monitors 92, 97.

As described above, according to the digital broadcast receiver 1 of Embodiment 6, acquisition of a program still image is indicated by a graphic, and therefore the user can understand that acquisition of a program still image is underway easily.

### Embodiment 7

In Embodiment 6, an example in which a graphic is displayed to indicate that acquisition of a program still image is underway is described. However, in Embodiment 7, an example in which a graphic is displayed to indicate whether or not the program still image is obtained successfully will be described.

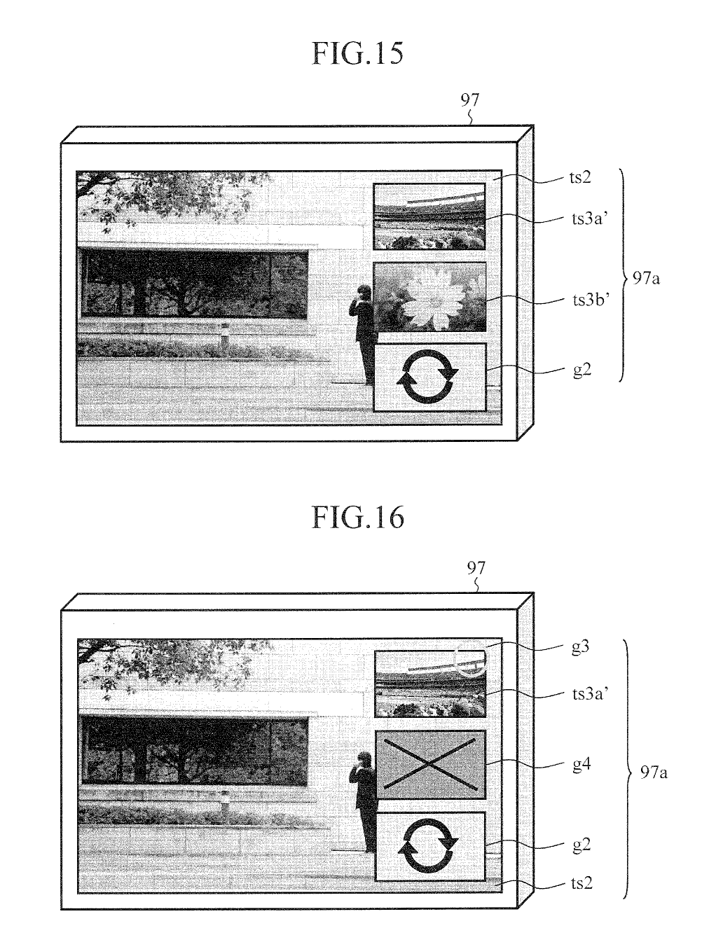

FIG. 16 is an image showing an example of a display screen on the monitor 97.

Note that the constitution of the digital broadcast receiver 1 is similar to that of FIGS. 9 and 10. Therefore, identical reference numerals are applied thereto, and these detailed descriptions are omitted.

As shown in FIG. 16, when a still image of a broadcast program is obtained successfully, a graphic g3 indicating this success is created by the graphic creation unit 33 and superimposed on the still image ts3a′ displayed on the slave screen.

When a still image of a broadcast program is not obtained successfully, a graphic g4 indicating this failure is created by the graphic creation unit 33 and displayed at an identical size to the slave screen.

As described above, according to the digital broadcast receiver 1 of Embodiment 7, the state of program still image acquisition is displayed when the still image is obtained, and as a result, the user can grasp the state of still image acquisition easily.

### Embodiment 8

In Embodiments 2 to 7, examples in which slave screens are displayed are described. In Embodiment 8, an example in which the broadcast program relating to the still image displayed on the slave screen and the broadcast program video displayed as the main display are switched will be described.

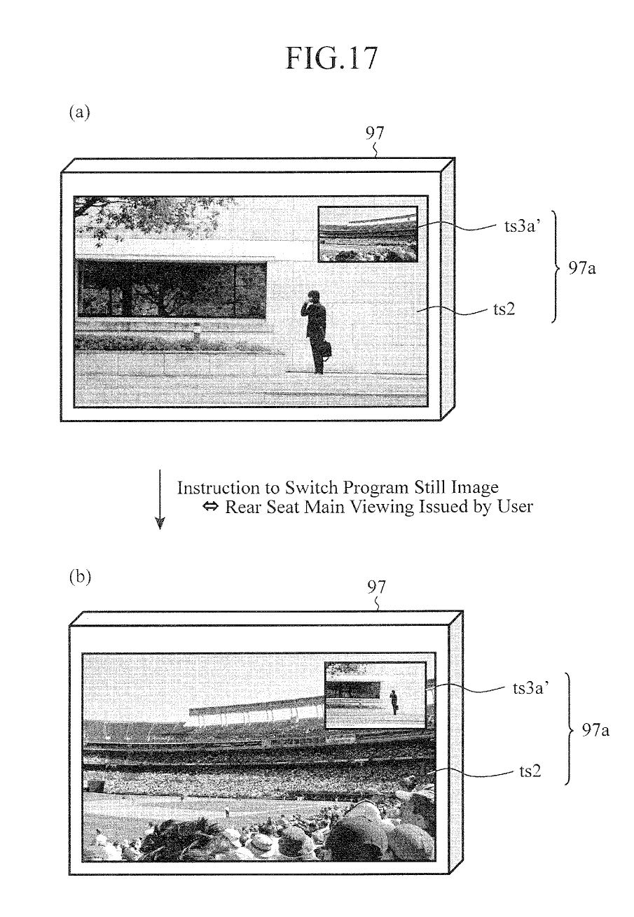

FIG. 17 is an image showing an example of a display screen on the monitor 97, wherein FIG. 17(a) shows a pre-switch display and FIG. 17(b) shows a post-switch display.

Note that the constitution of the digital broadcast receiver 1 is similar to that of FIGS. 9 and 10. Therefore, identical reference numerals are applied thereto, and these detailed descriptions are omitted.

When an operation instruction to switch the broadcast program video of the program still image and the main display broadcast program video is received from the user via the remote controller 96a, a still image is obtained from the main display broadcast program video and stored in the program still image storage unit 84, whereupon the stored still image is reduced and displayed as the slave screen ts3a′.

Simultaneously, the broadcast program information relating to the program still image is obtained from the broadcast information storage unit 82 such that when the channel selected by the tuner 22 of the broadcast reception unit 20 is changed, the rear seat monitor image 97a on the monitor 97 is switched from FIG. 17(a) to FIG. 17(b).

As described above, according to the digital broadcast receiver 1 of Embodiment 8, the broadcast program still image displayed on the slave screen and the broadcast program video displayed on the master screen can be switched on the basis of a user operation, and therefore the user can change the channel after checking the program content on the slave screen. As a result, the user can select a channel more easily.

### Embodiment 9

In Embodiments 1 to 8, examples in which a different broadcast program is received by an available broadcast reception unit and displayed on a slave screen are described. However, in Embodiment 9, an example in which the number of available broadcast reception units is displayed will be described.

Note that the constitution of the digital broadcast receiver 1 is similar to that of FIGS. 9 and 10. Therefore, identical reference numerals are applied thereto, and these detailed descriptions are omitted.

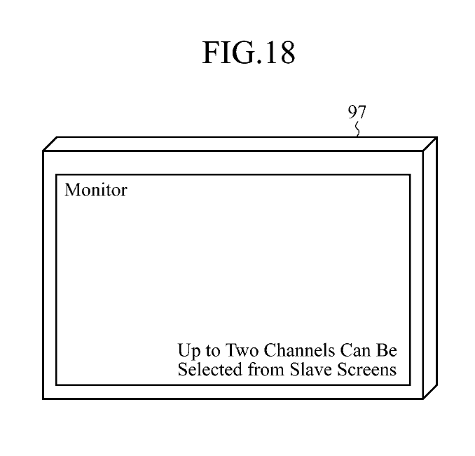

FIG. 18 is an image showing a number of channels that can be selected from slave screens, which is displayed on the monitor.

As shown in FIG. 18, “Up to two channels can be selected from slave screens” is displayed in a lower portion of the screen of the monitor 97. This means that of the three broadcast reception units 10, 20, 100, for example, only one broadcast reception unit 20 is receiving a broadcast program and the other two broadcast reception units 10, 100 are not receiving broadcasts.

First, the control unit 83 detects the number of available broadcast reception units. Then, on the basis of a detection signal transmitted from the control unit 83, the graphic creation unit 33 creates the display text “Up to two channels can be selected from slave screens” from the number of available broadcast reception units 10, 100. The created display text is transmitted to the display control unit 71, and the display control unit 71 synthesizes the display text with the broadcast program video. The synthesized broadcast program video is then displayed on the monitor 97.

As described above, according to the digital broadcast receiver 1 of Embodiment 9, the control unit 83 detects the broadcast reception units not receiving broadcasts, whereupon the number of broadcast reception units not receiving broadcasts is displayed on the monitor as the number of broadcast programs that can be selected on slave screens. As a result, the user can select a channel after seeing the number of broadcast programs that can be selected.

Note that in Embodiment 9, an example in which the number of broadcast programs that can be selected from slave screens is displayed is described. However, in a case where programs videos have been distributed such that no channels can be selected, the number of programs that can only be displayed on slave screens may be displayed on the monitor to inform the user of the broadcast programs that can be displayed on slave screens.

Further, in Embodiment 9, a display text is displayed on the monitor 97, but a display text may be displayed on the monitor 92 through a similar operation.

As described above, according to the digital broadcast receiver of the present invention, respective broadcast program videos from a plurality of broadcast reception units are distributed, whereupon at least one distributed program video is set as a master screen, another program video subjected to reduction processing in a video reduction unit is set as a slave screen, the master screen program video is synthesized with the slave screen program video, and the resulting program video is output. Hence, a master screen and a slave screen can be displayed on each of a plurality of monitors, and as a result, the viewers of the respective monitors can check a plurality of broadcast videos.

Further, the broadcast program video of the master screen and the broadcast program video of the slave screen can be switched on the respective monitors, and therefore the user can check the content of a broadcast program while viewing the slave screen. As a result, the user can select a channel easily.

Note that although the front seat side output unit 90 and the rear seat side output unit 95 are described in each of the embodiments, the output units are not limited to front seat side and rear seat side positions, and the disposal locations thereof may be determined appropriately in accordance with design requirements.

Further, examples in which broadcast program videos are displayed on the master screen and slave screen of the monitors 92, 97 are described in each of the embodiments, but a data broadcast included in the broadcast information may also be displayed.

### INDUSTRIAL APPLICABILITY

The digital broadcast receiver according to the present invention is capable of displaying a master screen and a slave screen on each of a plurality of monitors, and consequently viewers of the respective monitors can check a plurality of broadcast videos. Therefore, the digital broadcast receiver according to the present invention is suitable for use as a digital broadcast receiver or the like that has a Picture in Picture function and displays program videos selectively received by a plurality of broadcast reception units on a plurality of monitors capable of displaying the individual program images selectively.

1. A digital broadcast receiver comprising:
a plurality of monitors for displaying broadcast programs as program videos;
a plurality of broadcast reception units for receiving broadcast waves of the broadcast programs and demodulating the broadcast waves into broadcast program data;
a digital decoding unit for separating program video information from the respective broadcast program data demodulated by the plurality of broadcast reception units and decoding the program video information into program videos;
a video selection/synthesis unit including a video distribution unit for distributing the program videos decoded by the digital decoding unit, and a video synthesis unit for setting at least one of the program videos distributed by the video distribution unit as a master screen, setting another program video subjected to reduction processing by a video reduction unit as a slave screen, synthesizing the master screen program video with the slave screen program video, and outputting the synthesized program video; and
a control unit, provided with an operation input unit for receiving an operation of the monitor from a user, for controlling operations of the broadcast reception units, the digital decoding unit, and the video selection/synthesis unit on the basis of an input from the operation input unit, to thus display videos of the broadcast programs received by the broadcast reception units on the monitors.

2. The digital broadcast receiver according to claim 1, wherein the operation input unit receives an operation of each of the plurality of monitors, and on the basis of an input from the operation input unit, the control unit performs switching such that the broadcast program displayed on the monitor as the master screen is displayed as the slave screen, and the broadcast program displayed as the slave screen is displayed as the master screen.

3. The digital broadcast receiver according to claim 1, further comprising a program still image storage unit for storing program still images of the broadcast programs received by the broadcast reception units,
wherein, when the control unit detects a broadcast reception unit that is not receiving a broadcast program, channel selection is performed sequentially by the broadcast reception unit not receiving a broadcast program and program still images of the received broadcast programs are stored in the program still image storage unit, whereupon the stored program still images are read in a predetermined sequence, reduced by the video reduction unit, and displayed on the monitor as slave screens.

4. The digital broadcast receiver according to claim 1, wherein, when identical broadcast programs are being received by the plurality of broadcast reception units, the control unit controls the video selection/synthesis unit and the broadcast reception units such that a video received by one of the broadcast reception units is distributed to the plurality of monitors displaying an identical broadcast program, whereby a broadcast program to be displayed on the slave screen is received by the broadcast reception unit that no longer needs to perform reception.

5. The digital broadcast receiver according to claim 1, wherein the control unit detects broadcast reception units not receiving broadcast programs and displays a number of programs that can be selected from slave screens.

6. The digital broadcast receiver according to claim 1, wherein the control unit detects broadcast reception units not receiving broadcast programs and displays a number of programs that can be displayed on slave screens.
